(19) United States
(12) Patent Application Publication
(10) Pub. No.: US 2024/0172268 A1
(43) Pub. Date: May 23, 2024

(54) Method for Creating a Prioritization of Communications in an Environment

(71) Applicant: Bayerische Motoren Werke Aktiengesellschaft, Muenchen (DE)

(72) Inventors: Stefan DIEWALD, Moosburg a. d. Isar (DE); Daniel KUELZER, Muenchen (DE); Alaa MOURAD, Muenchen (DE)

(21) Appl. No.: 18/517,093

(22) Filed: Nov. 22, 2023

(30) Foreign Application Priority Data
Nov. 23, 2022 (DE) 10 2022 130 979.7

(51) Int. Cl. H04W 72/566; H04W 64/00; H04W 72/12

(52) U.S. Cl. CPC H04W 72/566; H04W 64/006; H04W 72/12

(57) ABSTRACT

A method is provided for generating a prioritization of communications in an environment, wherein the environment includes multiple communication units, and wherein the multiple communication units communicate on different frequencies. The method includes the steps of: detecting multiple communication units in the vicinity; acquiring for each of the detected multiple communication units respectively status information relating to the corresponding communication unit; and generating a prioritization of communications of the detected multiple communication units based on the status information of all of the detected multiple communication units.

### CROSS REFERENCE TO RELATED APPLICATION

This application claims priority under 35 U.S.C. § 119 from German Patent Application No. 10 2022 130 979.7, filed Nov. 23, 2022, the entire disclosure of which is herein expressly incorporated by reference.

### BACKGROUND AND SUMMARY

The present invention relates to a method for generating a prioritization of communications in an environment, wherein the environment comprises multiple communication units, and wherein the multiple communication units communicate on different frequencies.

An environment is understood to be an area or an enclosed unit that has multiple communication units or a system that has multiple radio systems, for example a motor vehicle or an Internet-of-Things system. A communication unit refers to a unit that transmits signals, in particular radio signals in the radio wave range, in order to communicate or interact with other communication units, other units or persons. The fact that the multiple communication units communicate on different frequencies also means that at least two of the multiple communication units communicate in different communication protocols, in particular different radio protocols, for example different networks.

Motor vehicles, for example, are increasingly equipped with a variety of such communication units. These include, for example, Bluetooth communication units for making telephone calls or streaming music, Wi-Fi communication units for video streaming and data exchange, ultra-wideband communication units for position determination, Bluetooth low-energy communication units for communicating with vehicle keys and sensors, such as optical sensors for detecting objects.

A disadvantage of this is that the communications of the individual communication units in such an environment are usually uncoordinated, so that, for example, the communications of the individual communication units may interfere with or influence each other. Consequently, there is a need for a method that enables improved control of the communications of multiple communication participants in an environment.

A device is known from the publication DE 10 2006 040 442 A1, which comprises a first control unit and multiple second control units of a road motor vehicle and a bus system which connects the control units, wherein an activity of the control units is dependent on a communication taking place between the control units via the bus system. Furthermore, the first control unit is designed so as not to allow communication on the bus system under predetermined conditions, and the second control units are designed so as to refrain from communicating on the bus system if the first control unit does not allow communication.

The object of embodiments of the invention is to provide a method for enabling improved control of the communications of multiple communication participants in an environment.

This object is achieved by the subject matter of the independent claims. Further advantageous developments are the subject of the dependent claims.

According to one embodiment of the invention, this object is achieved by a method for generating a prioritization of communications in an environment, wherein the environment comprises multiple communication units, and wherein the multiple communication units communicate on different frequencies, wherein the method comprises detecting multiple communication units in the environment, acquiring for each of the detected multiple communication units respectively status information relating to the corresponding communication unit, and generating a prioritization of communications of the detected multiple communication units based on the status information of all of the detected multiple communication units.

Prioritization of communications is understood to mean that a priority or ranking of the individual communication units is defined during communication, i.e. which communication units should be given preferential treatment if multiple communication units communicate simultaneously and/or the available resources are not sufficient in order to fully serve all currently running communications.

The fact that multiple communication units are detected in the environment also means that at least one portion of the multiple communication units in the environment, and in particular the communication units that could communicate in the near future, are detected or recorded.

Status information is also understood to mean information relating to the current status or the current condition of a communication unit. This can, for example, be acquired by sensors and/or stored in corresponding control units.

The fact that such a prioritization is generated has the advantage that, in the case of multiple communication units in an environment, wherein the multiple communication units communicate on different frequencies, the available resources can be optimally utilized and the communications of the communication units can be coordinated, for example, in such a way that the communications of the individual communication units do not interfere with or influence each other, especially if the resources currently available are not sufficient in order to optimally execute all currently running communications.

Overall, a method is thus provided which enables improved control of the communications of multiple communication participants in an environment.

The method can also comprise detecting whether a new communication unit is present in the environment and updating the prioritization if a new communication unit is present in the environment.

A new communication unit is understood to be an unknown, previously undetected communication unit.

The fact that the prioritization is updated also means that it is updated based on the new communication unit or the status information relating to the new communication unit without it having to be completely regenerated.

The fact that the prioritization is updated and not newly generated has the advantage that delays and thus also latencies can be avoided in the subsequent control of the communications based on the prioritization.

Furthermore, the method may also comprise a step of detecting whether external interference is present and a step of updating the prioritization based on the external interference if external interference is present.

External interference is understood to mean interference or overlapping or impairment caused by units or electronic devices located outside the environment of persons located inside the environment.

This enables even more optimized control of the communications of multiple communication units in an environment. In addition, it is possible to avoid in turn delays and therefore also latencies in the subsequent control of the communications based on the prioritization, since the prioritization is updated and not regenerated.

The status information may further comprise respectively one or more items of general information about the corresponding communication unit, information about the status of the corresponding communication unit, information about a current position of the corresponding communication unit and information about a current position of the environment.

General information about a communication unit is understood to mean information relating to the general properties of the corresponding communication unit, for example the capacities of the corresponding communication unit, or whether it was already present in the environment from the outset or was only added later.

Information about the status of a communication unit is further understood to mean information about the functionality of the corresponding communication unit, for example whether it is currently switched on or whether the corresponding communication unit can be used in the given environment.

Information about the current position of a communication unit also includes information about the location of the corresponding communication unit at a current point in time or information about a current beam shape of the corresponding communication unit.

Information about a current position of an environment is also understood to mean information about the current location of the corresponding environment.

In particular, the status information can include information about all essential properties that can influence a quality of communication between the individual communication units.

However, the fact that the status information comprises respectively one or more items of general information about the corresponding communication unit, information about the status of the corresponding communication unit, information about a current position of the corresponding communication unit and information about a current position of the environment is only one possible embodiment. Rather, the status information can also include information about other properties, in particular properties that influence the quality of the communication of the individual communication units, for example a distance between two communication units.

The multiple communication units can also comprise sensors and/or an infotainment system of a motor vehicle and/or a unit for making telephone calls and/or a unit for exchanging data with external units.

A sensor, which is also referred to as a detector, (measurand or measurement) transducer or (measurement) probe, is a technical component that can detect certain physical or chemical properties and/or the material properties of its environment either qualitatively or quantitatively as a measurand.

An infotainment system is also a system of components that provides various comfort and safety functions, such as radio and multimedia, navigation and connectivity functions.

A unit for making telephone calls is also understood to be a unit via which telephone calls can be made, for example a hands-free system in a motor vehicle.

A unit for exchanging data with external units is also understood to be a unit that can communicate data, for example sensor data, to an external unit for further processing and/or receive data from an external unit.

In particular, the multiple communication units can include all communication units that can influence each other in a corresponding environment, for example a motor vehicle.

However, the fact that the multiple communication units comprise sensors and/or an infotainment system of a motor vehicle and/or a unit for making telephone calls and/or a unit for exchanging data with external units is only one possible embodiment. Rather, the communication units can also comprise other communication units that occur in such an environment, for example additional radio devices.

The environment can also be a motor vehicle. In motor vehicles in particular, it is disadvantageous that the communications of individual communication units or control units are usually uncoordinated, so that, for example, the communications of the individual communication units may interfere with or influence each other.

However, the fact that the environment is a motor vehicle is only one possible embodiment. Rather, the environment can also be another self-contained unit that has multiple communication units or a system that has multiple radio systems, for example an Internet-of-Things system.

A further embodiment of the invention also provides a method for controlling communications in an environment, wherein the environment comprises multiple communication units, and wherein the communication units communicate on different frequencies, wherein the method comprises generating a prioritization of communications of the multiple communication units in the environment by a method as described above for generating a prioritization of communications in an environment, receiving an attempt of one of the multiple communication units to initiate a communication, and controlling the initiated communication and simultaneously running communications of further ones of the multiple communication units based on the generated prioritization and currently available resources.

The fact that one of the multiple communication units is attempting to initiate a communication means that the corresponding communication unit wants to start or establish a communication.

The fact that the communications of the communication units are controlled also means that the individual communication units are allocated corresponding resources for communication, for example channels in the spectrum, or time slots for communication, i.e. simultaneously running communications are coordinated in terms of time, simultaneously running communications are coordinated in terms of space, for example communication units in a certain spatial area are given preferential treatment, or interference is transferred to communications with a comparatively low priority if necessary.

Thus, a method for controlling communications in an environment is provided, which enables improved control of the communications of multiple communication participants in an environment. The fact that a prioritization is generated has the advantage that, in the case of multiple communication units in an environment, wherein the multiple communication units communicate on different frequencies, the available resources can be optimally utilized and the communications of the communication units can be coordinated, for example, in such a way that the communications of the individual communication units do not interfere with or influence each other, in particular if the resources currently available are not sufficient in order to optimally execute all currently running communications.

The step of controlling the initiated communication and simultaneously running communications of further ones of the multiple communication units may comprise controlling the initiated communication and the simultaneously running communications of further ones of the multiple communication units based on the generated prioritization, currently available resources and information about requirements for the communication of at least one portion of the multiple communication units.

Requirements for the communication of a communication unit are understood to be specifications or prerequisites that must be fulfilled so that the corresponding communication unit can communicate as intended, for example corresponding minimum requirements for resources and/or ideally required resources.

This allows the control of communications to be optimized even further.

A further embodiment of the invention also further discloses a system for generating a prioritization of communications in an environment, wherein the environment comprises multiple communication units, and wherein the multiple communication units communicate on different frequencies, wherein the system comprises at least one detection unit which is designed so as to detect multiple communication units in the environment, at least one acquisition unit which is designed so as to acquire for each of the detected multiple communication units respectively status information relating to the corresponding communication unit, and a generation unit which is designed so as to generate a prioritization of communications of the detected multiple communication units based on the status information of all of the detected multiple communication units, wherein the system is designed so as to perform a method described above for generating a prioritization of communications of multiple communication units in an environment.

Thus, a system for generating a prioritization of communications of multiple communication units in an environment is provided, which enables improved control of the communications of multiple communication participants in an environment. The fact that a prioritization is generated has the advantage that in the case of multiple communication units in an environment, wherein the multiple communication units communicate on different frequencies, the available resources can be optimally utilized and the communications of the communication units can be coordinated, for example, in such a way that the communications of the individual communication units do not interfere with or influence each other, in particular if the resources currently available are not sufficient in order to optimally execute all currently running communications.

A further embodiment of the invention also provides a system for controlling communications in an environment, wherein the environment comprises multiple communication units, and wherein the multiple communication units communicate on different frequencies, wherein the system comprises a provisioning unit which is designed so as to provide a prioritization of communications of the multiple communication units in the environment, wherein the prioritization has been generated by a system described above for generating a prioritization of communications of multiple communication participants in an environment, a detection unit which is designed so as to detect that one of the multiple communication units is attempting to initiate a communication, and a control unit which is designed so as to control the initiated communication and simultaneously running communications of further ones of the multiple communication units based on the generated prioritization and currently available resources.

Thus, a system for controlling communications of multiple communication units in an environment is provided, which enables improved control of the communications of multiple communication participants in an environment. The fact that prioritization is generated has the advantage that, in the case of multiple communication units in an environment, wherein the multiple communication units communicate on different frequencies, the available resources can be optimally utilized and the communications of the communication units can be coordinated, for example, in such a way that the communications of the individual communication units do not interfere with or influence each other, in particular if the resources currently available are not sufficient in order to optimally execute all currently running communications.

The control unit can be designed in turn so as to control the initiated communication and the simultaneously running communications of further ones of the multiple communication units based on the generated prioritization, currently available resources and information about the communication requirements of at least one portion of the multiple communication participants. This allows the control of the communications by the system to be further optimized.

A further embodiment of the invention also discloses a computer program product which comprises instructions which, when the program is executed by a computer, cause the computer to perform a method described above for generating a prioritization of communications in an environment.

The computer program product has the advantage that it is designed so as to perform a method for generating a prioritization of communications of multiple communication units in an environment, which enables improved control of the communications of multiple communication participants in an environment. The fact that a prioritization is generated has the advantage that in the case of multiple communication units in an environment, wherein the multiple communication units communicate on different frequencies, the available resources can be optimally utilized and the communications of the communication units can be coordinated, for example, in such a way that the communications of the individual communication units do not interfere with or influence each other, in particular if the resources currently available are not sufficient in order to optimally execute all currently running communications.

In summary, the present invention provides a method for generating a prioritization of communications in an environment, wherein the environment comprises multiple communication units, and wherein the multiple communication units communicate on different frequencies.

The invention will now be explained in more detail with reference to the enclosed figures.

### BRIEF DESCRIPTION OF THE DRAWINGS

FIG. 1 is a flowchart of a method for controlling communications in an environment according to embodiments of the invention; and

FIG. 2 is a schematic block diagram of a system for controlling communications in an environment and a system for generating a prioritization of communications in an environment according to embodiments of the invention.

### DETAILED DESCRIPTION OF THE DRAWINGS

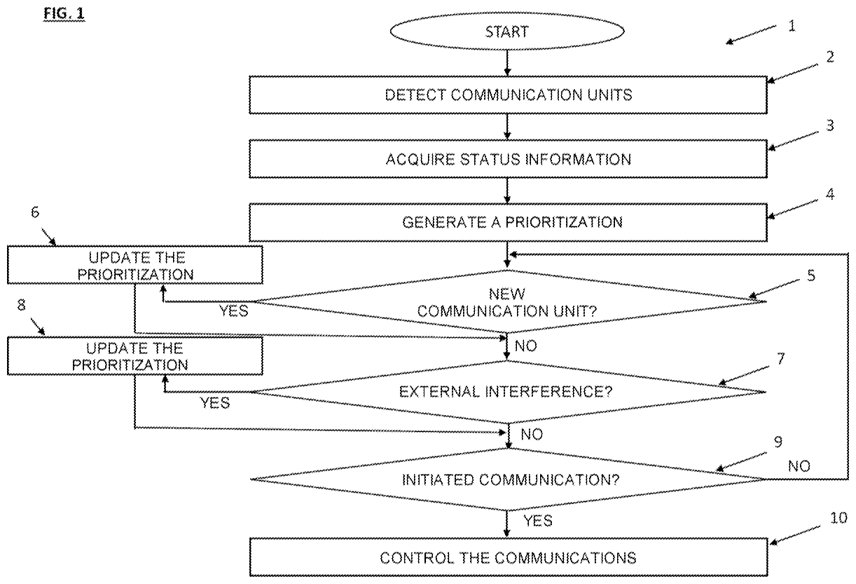

FIG. 1 shows a flowchart of a method for controlling communications in an environment 1 according to embodiments of the invention.

In particular, FIG. 1 shows a flowchart of a method for controlling communications in an environment, wherein the environment comprises multiple communication units, and wherein the multiple communication units communicate on different frequencies.

Motor vehicles, for example, are increasingly equipped with a variety of communication units. These include, for example, Bluetooth communication units for making telephone calls or streaming music, Wi-Fi communication units for video streaming and data exchange, ultra-wideband communication units for position determination, Bluetooth low-energy communication units for communicating with vehicle keys and sensors, such as optical sensors for detecting objects.

A disadvantage is that the communications of the individual communication units in such an environment are usually uncoordinated, so that, for example, the communications of the individual communication units may interfere with or influence each other. Consequently, there is a need for a method that enables improved control of the communications of multiple communication units in an environment.

FIG. 1 shows a method 1, wherein in a step 2 multiple communication units are detected in the environment. In a step 3, status information relating to the corresponding communication unit is acquired for each of the detected multiple communication units. And, in a step 4, a prioritization of communications of the detected multiple communication units is generated based on the status information of all of the detected multiple communication units.

The fact that such prioritization is generated has the advantage that in the case of multiple communication units in an environment, wherein the multiple communication units communicate on different frequencies, the available resources, for example power, available channels in the spectrum and/or available bandwidths, can be optimally utilized and the communications of the communication units can be coordinated, for example, in such a way that the communications of the individual communication units do not interfere with or influence each other, especially if the currently available resources are not sufficient in order to optimally execute all currently running communications.

Overall, a method 1 is thus provided, which enables improved control of the communications of multiple communication participants in an environment.

According to the embodiments of FIG. 1, step 2 of detecting the communication units involves the detection of communication units by a central generation unit on which the prioritization is generated. For this purpose, the central generation unit can, for example, comprise a code in order to automatically recognize communication units or control units which are connected to an environment or a data bus, for example a CAN bus. Furthermore, the individual communication units can also be registered with the central generation unit when the corresponding communication unit is installed, wherein further specifications to be taken into account when generating the prioritization, such as the routines of a buyer, can also be specified when the corresponding communication unit is registered.

The generated prioritization can then be stored in a memory, in particular in a non-volatile memory. According to the embodiments of FIG. 1, a user can retrieve the generated prioritization from the memory and then adapt or update it according to their behavior or routines and/or based on a current situation and functions that are important in the current situation.

Furthermore, the prioritization can be stored in the form of a matrix, which in each case has a link between a communication unit and a corresponding priority or resources which are assigned to the corresponding communication unit within the underlying environment.

As FIG. 1 shows, the method 1 also has a step 5 of detecting whether there is a new communication unit in the environment. If it is detected in step 5 that there is a new communication unit in the environment, the generated prioritization is updated accordingly in step 6. Otherwise, the previously generated prioritization remains unchanged.

The original prioritization can, for example, be generated after the corresponding environment has been created or commissioned and then updated accordingly in order to take into account new communication units that did not originally exist and at the same time avoid delays in the corresponding communication control.

Detecting whether there is a new communication unit in the environment in step 5 can also take place continuously or at certain predefined points in time or after predefined time intervals have elapsed.

According to the embodiments of FIG. 1, the method 1 further comprises a step 7 of detecting whether external interference is present, for example caused by other objects located outside the environment or by electronic devices, for example smartphones, of persons located within the environment. If it is detected in step 7 that external interference is present, the prioritization generated is updated accordingly in step 8. Otherwise, the previously generated prioritization remains unchanged.

Step 7 of detecting whether external interference is present can again be carried out continuously or at certain predefined points in time or after predefined time intervals have elapsed.

According to the embodiments of FIG. 1, the status information further comprises in each case general information about the corresponding communication unit, information about the status of the corresponding communication unit, information about a current position of the corresponding communication unit and information about a current position of the environment.

The data can, for example, be acquired by corresponding sensors and/or read from control units.

It is possible from the information about the current position of the environment, for example based on a stored look-up table, to determine whether legal requirements must be taken into account when generating the prioritization, for example whether special communication units must always be switched on or off at the current location.

The multiple communication units also comprise sensors, for example LiDAR or radar sensors, an infotainment system of a motor vehicle, a unit for making telephone calls and a unit for exchanging data with external units.

The environment is also a motor vehicle, wherein the communication units are control units of the motor vehicle.

For example, a control unit for starting the engine can be assigned a higher priority than a tire pressure measurement, wherein the tire pressure measurement can be assigned in turn a higher priority than a hands-free system for making telephone calls.

As FIG. 1 further shows, the method further comprises a step 9 of detecting whether one of the multiple communication units is attempting to initiate a communication. If one of the multiple communication units is attempting to initiate a communication, the initiated communication and simultaneously running communications of further ones of the multiple communication units are controlled in a step 10 based on the generated prioritization and resources currently available within the underlying environment. Otherwise, steps 5 to 9 are repeated.

Controlling the initiated communication in step 10 may involve allocating corresponding resources to this communication, for example channels in the spectrum, time windows for communication, i.e. temporal synchronization or coordination of the simultaneously running communications, or spatial synchronization or coordination of the simultaneously running communications, which may, for example, specify that communications in the area of a driver's seat of a motor vehicle are to be given preferential treatment, based on a corresponding optimization algorithm. If multiple communications want to use the same channels simultaneously, a quality of service (QoS) mechanism can also be used, for example.

The step 9 of detecting whether one of the multiple communication units is attempting to initiate a communication can again take place continuously or at certain predefined points in time or after predefined time intervals have elapsed.

According to the embodiments of FIG. 1, the step 10 of controlling the initiated communication and simultaneously running communications of further ones of the multiple communication units comprises controlling the initiated communication based on the generated prioritization, currently available resources and information about requirements for the communication of at least one portion of the multiple communication units.

In particular, the initiated communication and simultaneously running communications of further ones of the multiple communication units can be controlled in such a way that the resources of the underlying environment are optimally utilized. The communication can be controlled in such a way that, if the resources of the underlying environment are not sufficient in order to ideally execute the initiated communication and communications or applications already running at the point in time the communication is initiated, higher priority communications are given preferential treatment and/or interference is shifted to communications with a lower priority.

As soon as the initiated communication has ended, the resources allocated to it can be released again and made available for other communications.

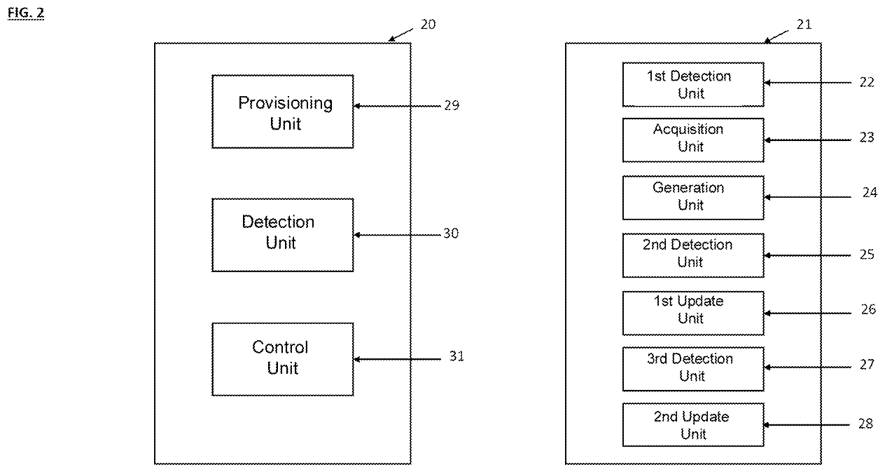

FIG. 2 shows a schematic block diagram of a system for controlling communications in an environment 20 and a system for generating a prioritization of communications in an environment 21 according to embodiments of the invention.

In particular, FIG. 2 shows a system for controlling communications in an environment 20, wherein the communication comprises multiple communication units, and wherein the multiple communication units communicate on different frequencies. In addition, FIG. 2 shows a corresponding system for generating a prioritization of communications in an environment 21.

As shown in FIG. 2, the system for generating a prioritization of communications in an environment 21 comprises a first detection unit 22 which is designed so as to detect multiple communication units in the environment, an acquisition unit 23 which is designed so as to acquire status information relating to the corresponding communication unit for each of the detected multiple communication units, and a generation unit 24 which is designed so as to generate a prioritization of communications of the detected multiple communication units based on the status information of all of the detected multiple communication units.

In this case, the system for generating a prioritization of communications in an environment 21 is designed so as to detect multiple communication units in the environment, to acquire for each of the detected multiple communication units respectively status information relating to the corresponding communication unit, and to generate a prioritization of communications of the detected multiple communication units based on the status information of all of the detected multiple communication units.

The acquisition unit 23 can comprise at least one sensor and/or be realized by a code which is stored in a memory and can be executed by a processor. The first detection unit 22 and the generation unit 24 can furthermore each be realized based on a code which is stored in a memory and can be executed by a processor, wherein the first detection unit 22 and the generation unit 24 can furthermore be integrated in turn into a common central unit.

As FIG. 2 further shows, the system 21 also has a second detection unit 25, which is designed so as to detect whether there is a new communication unit in the environment, and a first update unit 26, which is designed so as to update the prioritization accordingly if there is a new communication unit in the environment.

The second detection unit 25 and the first update unit 26 can be realized in turn based on a code which is stored in a memory and can be executed by a processor, wherein the second detection unit 25 and the first update unit 26 can also be integrated into the common central unit.

According to the embodiments of FIG. 2, the system 21 also has a third detection unit 27, which is designed so as to detect whether external interference is present, and a second update unit 28, which is designed so as to update the prioritization accordingly if external interference is present.

The third detection unit 27 and the second update unit 28 can in turn be realized based on a code which is stored in a memory and can be executed by a processor, wherein the third detection unit 27 and the second update unit 28 can also be integrated into the common central unit.

According to the embodiments of FIG. 2, the status information further comprises general information about the corresponding communication unit, information about the status of the corresponding communication unit, information about a current position of the corresponding communication unit and information about a current position of the environment.

The multiple communication units comprise in turn sensors, for example LiDAR or radar sensors, an infotainment system of a motor vehicle, a unit for making telephone calls and a unit for exchanging data with external units.

In addition, the environment is also a motor vehicle, wherein the communication units are control units of the motor vehicle.

The illustrated system for controlling communications in an environment 20 further comprises a provisioning unit 29 or receiving unit which is designed so as to receive a prioritization which is generated by the system for generating a prioritization of communications in an environment 21, a detection unit 30 which is designed so as to detect that one of the multiple communication units is attempting to initiate a communication, and a control unit 31 which is designed so as to control the initiated communication and simultaneously running communications of other of the multiple communication units based on the generated prioritization and currently available resources.

In particular, the provisioning unit 29 can be a receiver that is designed so as to receive corresponding data. Furthermore, the detection unit 30 and the control unit 31 can each be realized in turn, for example, based on a code which is stored in a memory and can be executed by a processor.

According to the embodiments of FIG. 2, the control unit 31 is designed so as to control the initiated communication and the simultaneously running communications of further ones of the communication participants based on the generated prioritization, the available resources and information about the communication requirements of at least one portion of the multiple communication participants.

The illustrated system 20 is further designed so as to perform a method described above for controlling communications in an environment.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

20 System
21 System
22 First detection unit
23 Acquisition unit
24 Generation unit
25 Second detection unit
26 First update unit
27 Third detection unit
28 Second update unit
29 Provisioning unit
30 Detection unit
31 Control unit

What is claimed is:

1. A method for generating a prioritization of communications in an environment, wherein the environment comprises multiple communication units, and wherein the multiple communication units communicate on different frequencies, the method comprising the steps of:
detecting multiple communication units in a particular vicinity;
acquiring, for each of the detected multiple communication units respectively, status information relating to the corresponding communication unit; and
generating a prioritization of communications of the detected multiple communication units based on the status information of all of the detected multiple communication units.

2. The method according to claim 1, wherein the method further comprises the steps of:
detecting whether there is a new communication unit in the vicinity; and
updating the prioritization based on the new communication unit when there is a new communication unit in the environment.

3. The method according to claim 1, wherein the method further comprises the steps of:
detecting whether external interference is present; and
updating the prioritization based on external interference when external interference is present.

4. The method according to claim 1, wherein
the status information comprises one or more of general information about the corresponding communication unit, information about a status of the corresponding communication unit, information about a current position of the corresponding communication unit, or information about a current position of the environment.

5. The method according to claim 1, wherein
the multiple communication units comprise sensors and/or an infotainment system of a motor vehicle and/or a unit for making telephone calls and/or a unit for exchanging data with external units.

6. The method according to claim 1, wherein the environment is a motor vehicle.

7. A method for controlling communications in an environment, wherein the environment comprises multiple communication units, and wherein the multiple communication units communicate on different frequencies, the method comprising the steps of:
(a) generating a prioritization of communications of the multiple communication units in the environment, wherein the generating comprises:
detecting multiple communication units in a particular vicinity;
acquiring, for each of the detected multiple communication units respectively, status information relating to the corresponding communication unit; and
generating the prioritization of communications of the detected multiple communication units based on the status information of all of the detected multiple communication units;
(b) detecting that one of the multiple communication units is attempting to initiate a communication; and
(c) controlling the initiated communication and simultaneously executed communications of further ones of the multiple communication units based on the generated prioritization and currently available resources.

8. The method according to claim 7, wherein
the step of controlling the initiated communication and simultaneously executed communications of further ones of the multiple communication units comprises:
controlling the initiated communication based on the generated prioritization, currently available resources, and information about requirements for communication of at least one portion of the multiple communication units.

9. A system for generating a prioritization of communications in an environment, wherein the environment comprises multiple communication units, and wherein the multiple communication units communicate on different frequencies, wherein the system comprises:
at least one detection unit which is designed so as to detect multiple communication units in the environment;
at least one acquisition unit which is designed so as to acquire, for each of the detected multiple communication units respectively, status information relating to the corresponding communication unit; and
a generation unit which is designed so as to generate a prioritization of communications of the detected multiple communication units based on the status information of all of the detected multiple communication units.

10. A system for controlling communications in an environment, wherein the environment comprises multiple communication units, and wherein the multiple communication units communicate on different frequencies, wherein the system comprises:
a provisioning unit which is designed so as to provide a prioritization of communications of the multiple communication units in the environment,
wherein the prioritization has been generated by a system comprising:
at least one detection unit which is designed so as to detect multiple communication units in the environment;
at least one acquisition unit which is designed so as to acquire, for each of the detected multiple communication units respectively, status information relating to the corresponding communication unit; and
a generation unit which is designed so as to generate a prioritization of communications of the detected multiple communication units based on the status information of all of the detected multiple communication units;
a detection unit which is designed so as to detect that one of the multiple communication units is attempting to initiate a communication; and
a control unit which is adapted so as, in response to one of the multiple communication units attempting to initiate a communication, to control the initiated communication and simultaneously executed communications of further ones of the multiple communication units based on the generated prioritization and currently available resources.

11. The system according to claim 10, wherein
the control unit is designed so as to control the initiated communication and simultaneously executed communications of further ones of the multiple communication units based on the generated prioritization, currently available resources and information about requirements for communication of at least one portion of the multiple communication participants.

12. A computer program product comprising a non-transitory computer readable medium having stored thereon program instructions which, when the program instructions are executed by a computer, cause the computer to carry out the acts of generating a prioritization of communications of multiple communication units in an environment by:
detecting multiple communication units in a particular vicinity;
acquiring, for each of the detected multiple communication units respectively, status information relating to the corresponding communication unit; and
generating a prioritization of communications of the detected multiple communication units based on the status information of all of the detected multiple communication units.
